(19) United States
(12) Patent Application Publication
(10) Pub. No.: US 2008/0034983 A1
(43) Pub. Date: Feb. 14, 2008

(54) Method And Apparatus For Forming A Cavity Within A Banana

(76) Inventor: Wojtek Banda, Queensland (AU)

Correspondence Address: SCHMEISER, OLSEN & WATTS, 22 CENTURY HILL DRIVE, SUITE 302, LATHAM, NY, 12110, US

(21) Appl. No.: 11/575,781

(22) PCT Filed: Sep. 28, 2005
(86) PCT No.: PCT/AU05/01494

§ 371 Date: Mar. 22, 2007

(30) Foreign Application Priority Data
Sep. 29, 2004 (AU) 2004214613

(51) Int. Cl. A23N 4/12; A23P 1/00

(52) U.S. Cl. 99/547; 426/442; 426/518; 426/615

(57) ABSTRACT

One aspect of the invention relates to an apparatus (2) for forming a cavity within a banana (1). The apparatus (2) includes a cutting tool (18) having an arcuate tubular cutter (7) extendible into the banana (1) to form a longitudinally extending cavity within the banana (1). Another aspect of the invention relates to a method for forming a cavity within a banana (1). The method includes the steps of moving a cutting tool (18) having an arcuate tubular cutter (7) into engagement with a banana (1) such that the cutter (7) extends into the banana (1) to form a longitudinally extending cavity within the banana (1), and removing the cutter (7) from the banana (1). Another aspect of the invention relates to a method of filling the banana (1) with a food product such as chocolate.

### TECHNICAL FIELD

This invention relates to a method and apparatus for forming a cavity within a banana. The invention also concerns, inter alia, a banana having a cavity filled with a food product.

### BACKGROUND ART

Devices for forming cavities within bananas, for subsequent filling with food products, are known. One such device is described in the specification of EP 1183973 and another device is described in the specification of U.S. Pat. No. 2,751,864. Both of the devices utilise a linear pulp cutter that is extendable longitudinally within the banana.

A disadvantage of using a linear cutter is that, since bananas are arcuate, it may not be possible to form a long cavity within the pulp of some bananas. This is particularly the case with bananas that have a small radius, such as Lady Finger bananas.

The present inventor has now developed an apparatus and method for forming a cavity within a banana which minimises or overcomes the disadvantage referred to above.

### DISCLOSURE OF INVENTION

According to a first aspect of the present invention, there is provided an apparatus for forming a cavity within a banana, said apparatus including at least one cutting tool having an arcuate tubular cutter extendible into a banana to form a longitudinally extending cavity within the banana.

The cutting tool may be of any suitable size, shape and construction. Preferably, the radius of the arc of the cutter is the same as or is similar to the radius of the banana, such that a cavity may be formed which extends almost the entire length of the banana. Preferably, the cutter is of greater length than the banana and is substantially semicircular when viewed in plan. The cutter may be of any suitable shape when viewed in transverse cross-section, e.g. triangular, round or rectangular. Preferably, the cutter is of circular transverse cross-section. Preferably, the cutter has a sharpened cutting end that cuts the banana. The cutter may have an outlet end opposite the cutting end and pulp that has been cut from the banana may pass through the outlet end. The cutter may be made of any suitable material or materials, such as plastics material, wood or metal. Preferably, the cutter is made of stainless steel.

The cutting tool may have a cutting blade located at the cutting end that may assist in cutting the pulp and ensuring that cut pulp, once having entered the cutter, cannot exit back through the cutting end. The cutting blade may be of any suitable size and shape. Preferably, the cutting blade extends vertically within the cutter adjacent the cutting end. Preferably, the cutting blade is wedge shaped and a cutting edge of the blade points towards the cutting end.

The cutting tool may be moved into and out of engagement with the banana in any suitable way. For instance, the cutting tool may be moved into engagement with the banana by hand, electrically, hydraulically or pneumatically. The apparatus may include a motor for moving the cutting tool and movement of the cutting tool may be controlled by way of a foot pedal. Preferably, the cutting tool is moved by hand.

The cutting tool may have a body and the cutter may extend within the body. The cutting tool may have a handle extending from the body. Preferably, the body is arcuate when viewed in plan, the cutter extends longitudinally and completely through the body, and the handle extends upwardly from the body. The body and handle may be made of any suitable material or materials, such as plastics material, wood or metal. The apparatus may have a positioning system for positioning the banana and the cutting tool relative to one another. The positioning system may be of any suitable size, shape and construction. In a preferred embodiment, the positioning system includes a support surface having at least one circular, semicircular or arcuate track within which the banana and the cutting tool are locatable. The track may guide the movement of the cutting tool relative to the banana. Preferably, the track is a groove in the support surface.

The support surface may include at least one opening through which pulp may fall after having passed through the outlet end of the cutter. Preferably, the opening is a slit extending longitudinally within the track.

The positioning system may include a cutter guide extending transversely of and across the track adjacent an end of the banana. The guide may have a body having an opening, the cutter may extend through the opening, and the cutter may slide relative to the cutter guide.

The apparatus may include a container located below the support surface for collecting pulp that has fallen through the opening. The container may be of any suitable size, shape and construction. The container may be mounted to a lower face of the support surface.

Preferably, pulp passes through the cutter outlet end as additional pulp enters the cutter via the cutting end. If desired, a vacuum pump may be used to draw pulp through the outlet end. Any suitable type of vacuum pump may be used.

The support surface may have at least one additional circular, semicircular or arcuate track and the apparatus may further include at least one additional cutting tool located within the additional track. Preferably, the tracks extend concentrically to one another. Preferably, three or four tracks extend concentrically and each track has a single cutting tool.

The cutter guide may extend transversely of and across each track adjacent an end of each banana. The cutter guide may have a body having a respective opening through which each cutter may extend. This arrangement enables bananas of differing radii to be cut on the same support surface.

According to a second aspect of the present invention, there is provided a method for forming a cavity within a banana, said method including the steps of:

moving a cutting tool having an arcuate tubular cutter into engagement with a banana such that the cutter extends into the banana to form a longitudinally extending cavity within the banana; and

removing the cutter from the banana.

The cutting tool may have one or more features as described in the first aspect of the invention. The cutting tool may be part of an apparatus as described in the first aspect of the invention.

According to a third aspect of the present invention, there is provided a method of filling a banana with a product, such as a food product, said method including the steps of:

moving a cutting tool having an arcuate tubular cutter into engagement with a banana such that the cutter extends into the banana to form a longitudinally extending cavity within the banana;

removing the cutter from the banana; and

filling the cavity with a product.

Preferably, the method includes the step of first removing the tip-end (ie. flowering end) of the banana so that the cutter is extendible directly into the pulp of the banana.

The cavity of the banana may be filled with any suitable type of product, such as a food product or a non-edible product such as a novelty item (eg. a toy). Preferably, the banana is filled with a food product. The food product may be, for example, chocolate, coffee or cream that is introduced into the cavity as a fluid.

The cavity may be filled in any suitable way. Preferably, an injector/caulking gun having a nozzle or a syringe is used to fill the cavity.

Preferably, the method includes the step of sealing the cavity after the cavity has been filled with the food product. The cavity may be sealed in any suitable way and using any suitable sealing agent. Preferably, the cavity is sealed by reattaching the tip-end of the banana to a remainder of the banana with beeswax.

Preferably, the method includes the step of cutting the stem-end (ie. stalk end) of the banana and sealing that end with beeswax, so that the banana is easier to peel.

According to a fourth aspect of the present invention, there is provided a banana having an arcuate cavity extending longitudinally therewithin.

The cavity may be formed by the method according to the second aspect of the invention.

Preferably, the cavity is filled with a product, preferably a food product. The food product may be, for example, chocolate, toffee or cream.

A tip-end of the banana may attached to a remainder of the banana with beeswax.

A stem-end of the banana may be cut and coated in beeswax.

According to a fifth aspect of the present invention, there is provided a workstation having the apparatus according to the first aspect of the invention, for carrying out the methods as hereinbefore described.

The workstation may include one or more of the following: a workbench; storage for holding bananas and the food product; a refrigerator and at least one heater for maintaining the food product and bananas at a select temperature; an injector for filling the banana cavity with the food product; a heater for heating the beeswax; a heater for heating the injector; a holder for holding the food product injector; a paper towel dispenser; a container for collecting waste pulp from bananas; a general waste container; and, a control panel for controlling and monitoring the refrigerator and heaters.

Preferred embodiments of the invention will now be described by way of example with reference to the accompanying drawings.

### BRIEF DESCRIPTION OF DRAWINGS

FIG. 1 is a detailed plan view of part of an apparatus for forming a cavity in a banana, according to an embodiment of the invention;

FIG. 2 is a perspective view of a cutting tool of the apparatus shown in FIG. 1;

FIG. 3 is a cross-sectional view taken through plane A-A of FIG. 1;

FIG. 4 is a detailed plan view of part of an apparatus for forming a cavity in a banana, according to another embodiment of the invention;

FIG. 5 is a detailed plan view of a banana having a cavity filled with a food product, according to an embodiment of the invention;

FIG. 6 is a detailed plan view of part of an apparatus for forming a cavity in a banana, according to another embodiment of the invention;

FIG. 7 is a detailed plan view of part of an apparatus for forming a cavity in a banana, according to an embodiment of the invention;

FIG. 8 is a front elevation view of a workstation having the apparatus of FIGS. 6 and 7, according to an embodiment of the invention;

FIG. 9 is a detailed top plan view of the workstation shown in FIG. 8;

FIG. 10 is a cross-sectional view of the workstation shown in FIG. 9;

FIG. 11 is another cross-sectional view of the workstation shown in FIG. 9;

FIG. 12 is another cross-sectional view of the workstation shown in FIG. 9; and

FIG. 13 is another cross-sectional view of the workstation shown in FIG. 9.

### BEST MODES FOR CARRYING OUT THE INVENTION

In the figures, like reference numerals refer to like features.

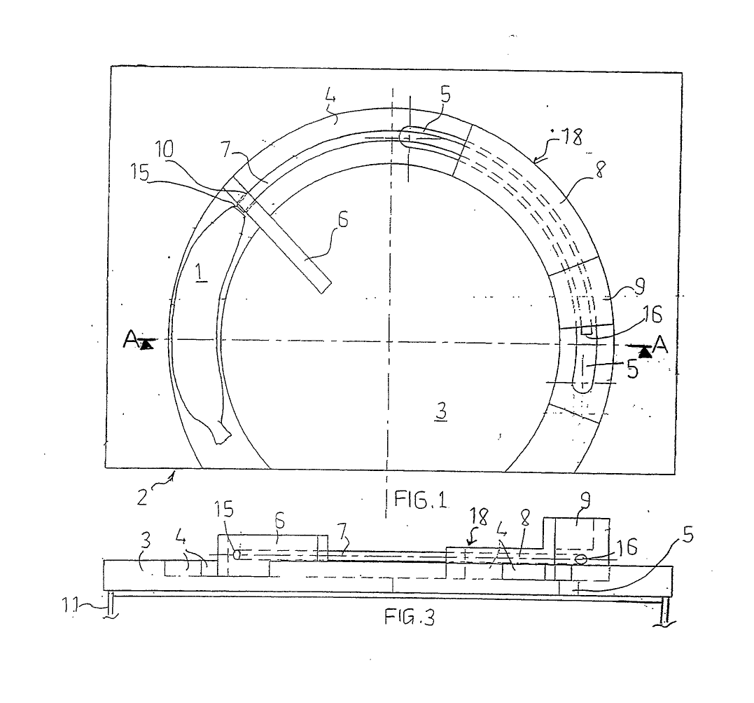

FIG. 1 shows a banana 1 as well as part of an apparatus 2 for forming a cavity in the banana 1. The apparatus 2 includes a board 3, an arcuate track/groove 4 extending along the board 3, a slofted opening 5 extending within the groove 4, and a guide block 6 extending transversely of and across the groove 4. The board 3 and guide 6 are made of wood or plastics material.

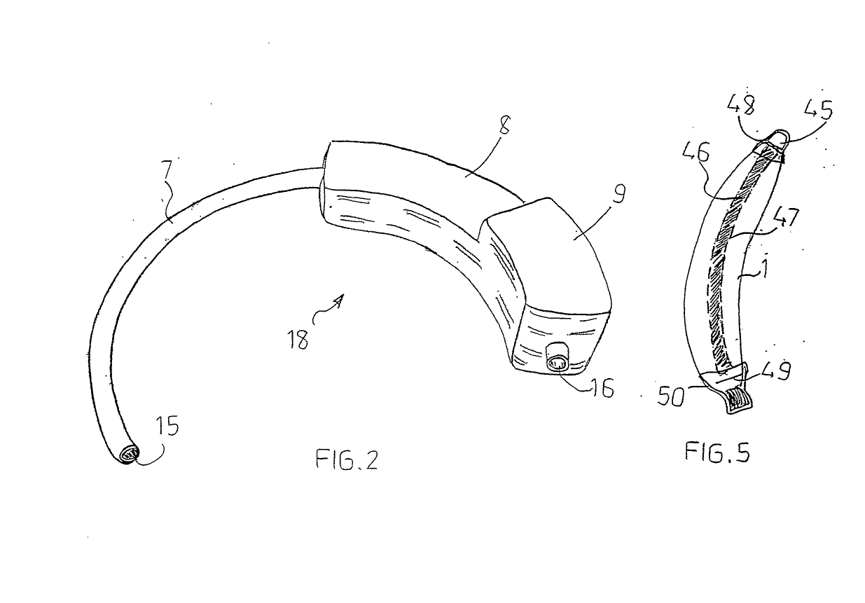

The apparatus 2 further includes a cutting tool 18 having a body 8, an arcuate tubular cutter 7 extending longitudinally and completely through the body 8, and a handle 9 extending upwardly from the body 8. The cutting tool 18 is best seen in FIG. 2.

As seen in FIG. 1, the body 8 is arcuate when viewed in plan and slideable within the groove 4. The cutter 7 extends through an opening 10 in the guide block 6. A sharpened cutting end 15 of the cutter 7 is an inlet for cut banana pulp. An outlet 16 for cut banana pulp is located at the other end of the cutter 7. The cutter 7 is made of stainless steel or plastics material. The body 8 and handle 9 are made of wood, metal or plastics material.

The apparatus 2 further includes a rectangular container 11 (as partly shown in FIG. 3) located below the board 3. The container 11 is used to collect cut banana pulp that has passed through the cutter outlet 16 and has fallen through the slotted opening 5.

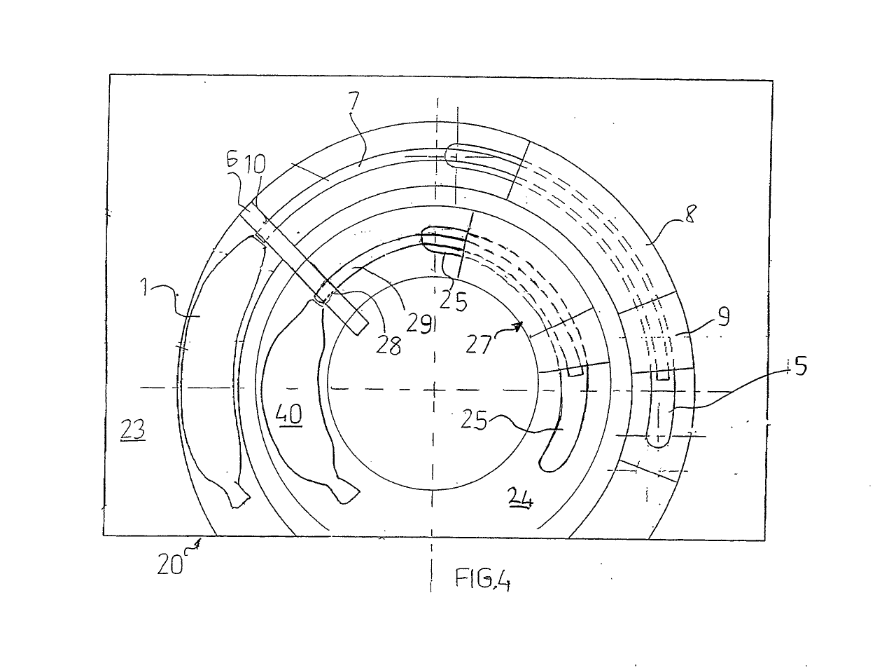

FIG. 4 shows an apparatus 20 like apparatus 2 but the board 23 has an additional groove 24 and a slotted opening 25. The apparatus 20 has an additional cutting tool 27. The guide block 6 has an additional opening 28 through which extends a cutter 29 of the cutting tool 27. A banana 40 having a different radius from the other banana 1 is located within the groove 24.

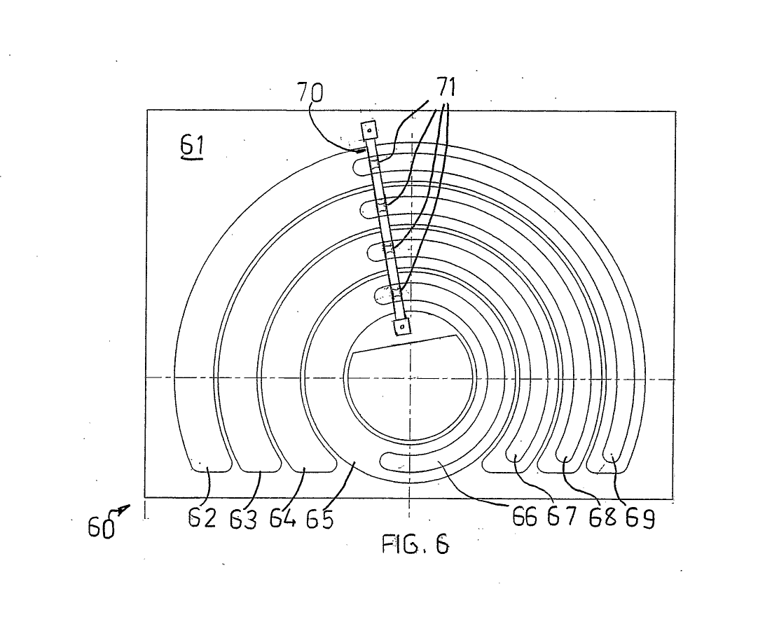

In use, a tip-end 45 of the banana 1 is cut and removed. The banana 1 is positioned within the groove 4 adjacent the guide block 6. An operator carefully extends the cutter 7 through the cut tip-end 45 longitudinally within the banana 1 by moving the handle 9 towards the banana 1. As the cutter 7 extends into the banana 1, cut pulp moves through the cutting end 15, further through the cutter outlet 16, falls through the slotted opening 5, and collects within the container 11. The cutter 7 is then withdrawn from the banana 1 to leave a cavity 47 which extends longitudinally within the banana 1 (as seen in FIG. 5).

The banana 1 is then removed from the groove 4 and the cavity 47 is filled with a food product 46 (e.g. molten chocolate) using an injector/caulking gun. The tip-end 45 is then reattached to the banana 1 using a coating of beeswax 48. The stem-end 49 of the banana 1 is also cut and then coated with beeswax 50 in order to make peeling the skin of the banana 1 easier. The beeswax 48, 50 ensures that the chocolate-filled banana I has a shelf life of about two days.

FIG. 6 shows part of an apparatus 60 for forming a cavity in a banana. The apparatus 60 is similar to apparatus 20, except that it has a board 61 having four concentric arcuate grooves 62-65. A slotted opening 66-69 extends within each groove 62-65. A guide block 70 having four tapered openings 71 extends transversely of and across the grooves 62-65.

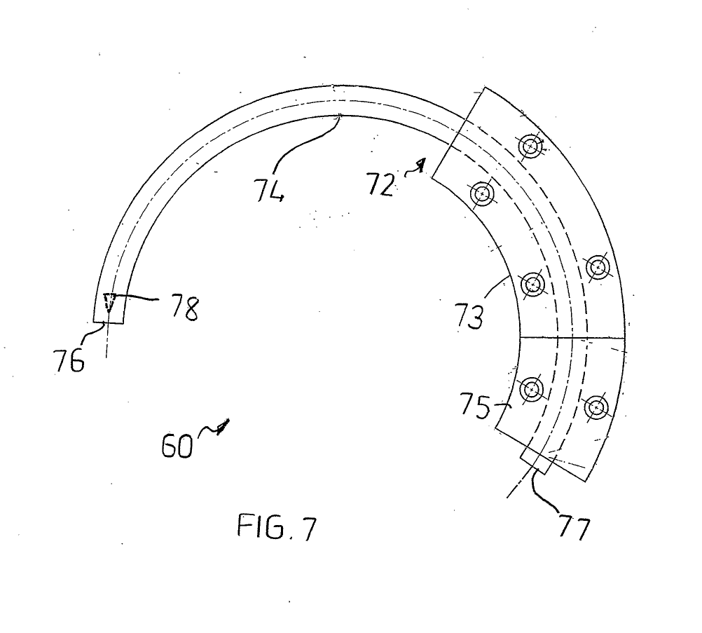

As seen in FIG. 7, the apparatus 60 further includes a cutting tool 72 having a body 73, an arcuate tubular cutter 74 extending longitudinally and completely through the body 73, and a handle 75 extending upwardly from the body 73. A sharpened cutting end 76 of the cutter 74 is an inlet for cut banana pulp. An outlet 77 for cut banana pulp is located at the other end of the cutter 74. The cutting tool 72 also has a wedge-shaped cutting blade 78 which helps cut pulp when inserted into a banana and prevents cut pulp from exiting via the cutting end 76. The cutting blade 78 extends vertically within the cutter 74 and a cutting edge of the cutting blade 78 points towards the cutting end 76.

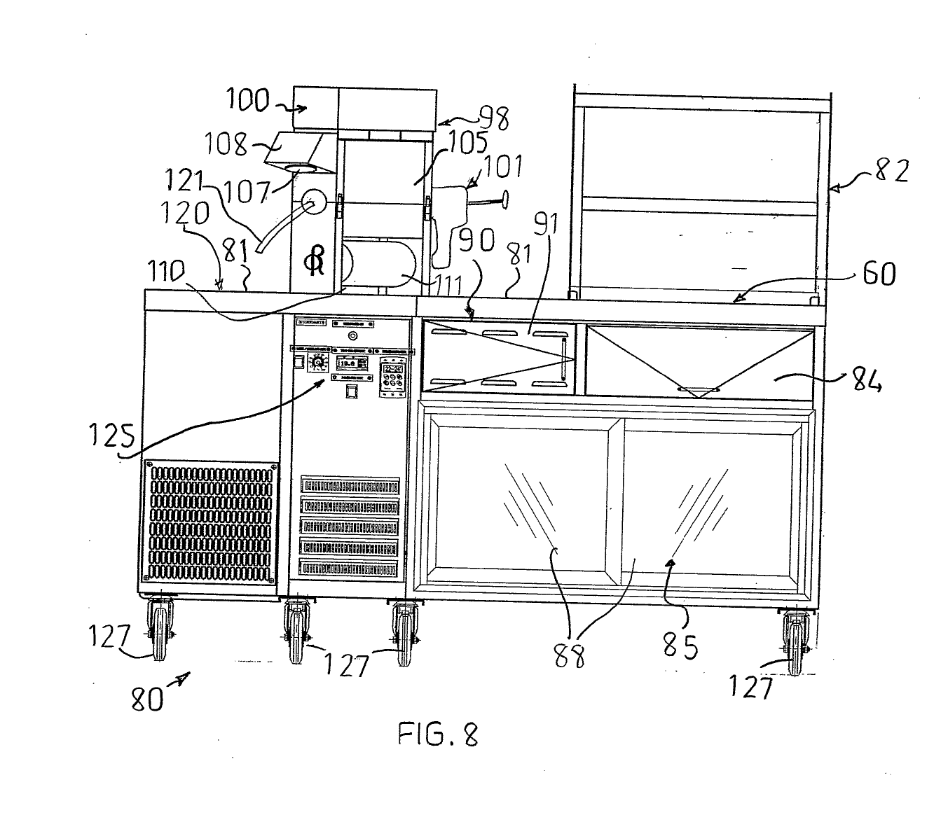

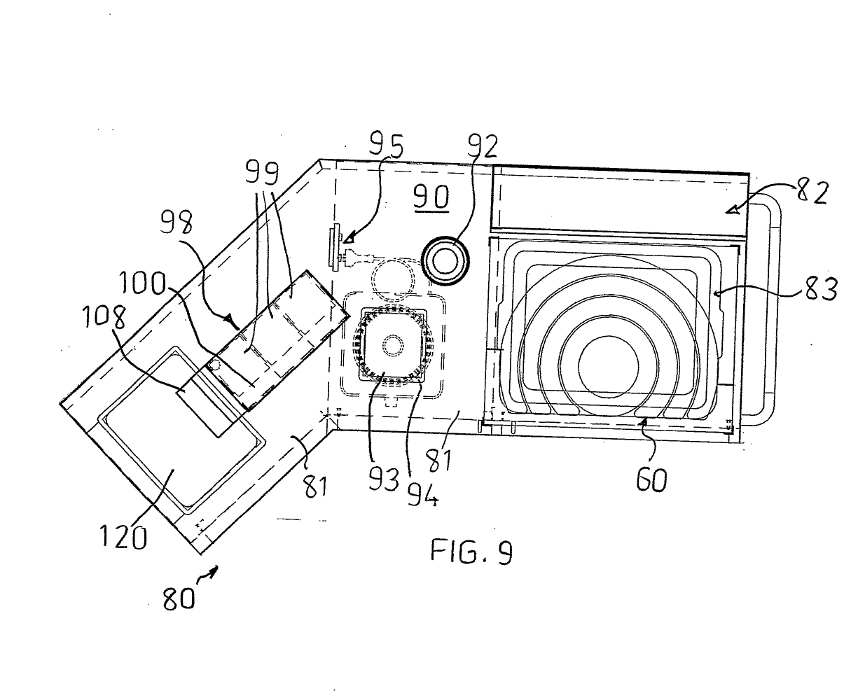

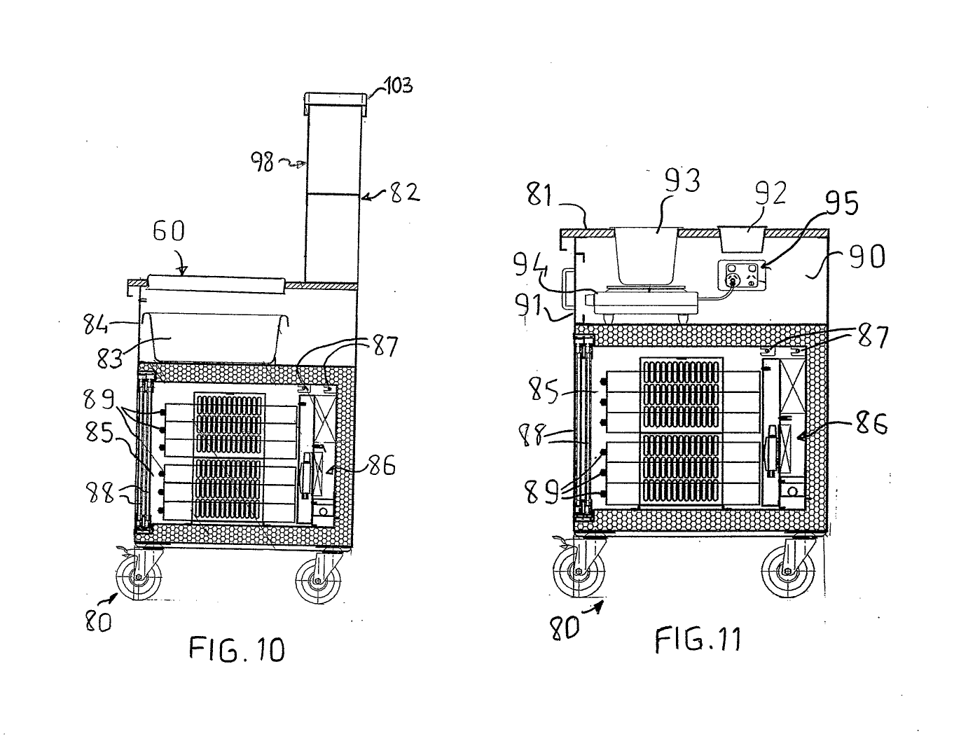

FIGS. 8-13 show a mobile workstation 80 for filling bananas with a food product such as chocolate. The workstation 80 includes a workbench 81 that supports the apparatus 60, as shown in FIG. 9. Shelves 82 for holding bananas extend from and above the workbench 81 adjacent the apparatus 60, as shown in FIG. 8. A bin 83 for waste banana pulp (best seen in FIG. 10) is located beneath the apparatus 60 and is contained within a drawer 84. A temperature-controlled compartment 85 containing a refrigeration unit 86 and heating elements 87 is located beneath the drawer 84. As seen in FIGS. 8 and 10, the compartment 85 is accessed by way of a pair of double glazed sliding doors 88. The compartment 85 maintains a rack of chocolate-filled cartridges 89 at a temperature of 22-24° C.

Referring now to FIGS. 8, 9 and 11, a compartment 90 located adjacent the drawer 84 is accessed by way of a door 91. The compartment 90 contains a container 92 for waste chocolate and beeswax, a melting pot 93 for beeswax, and a heating pad 94 that is located beneath the pot 93. A pair of power outlets 95 are also located within the compartment 90, as shown in FIGS. 9 and 11.

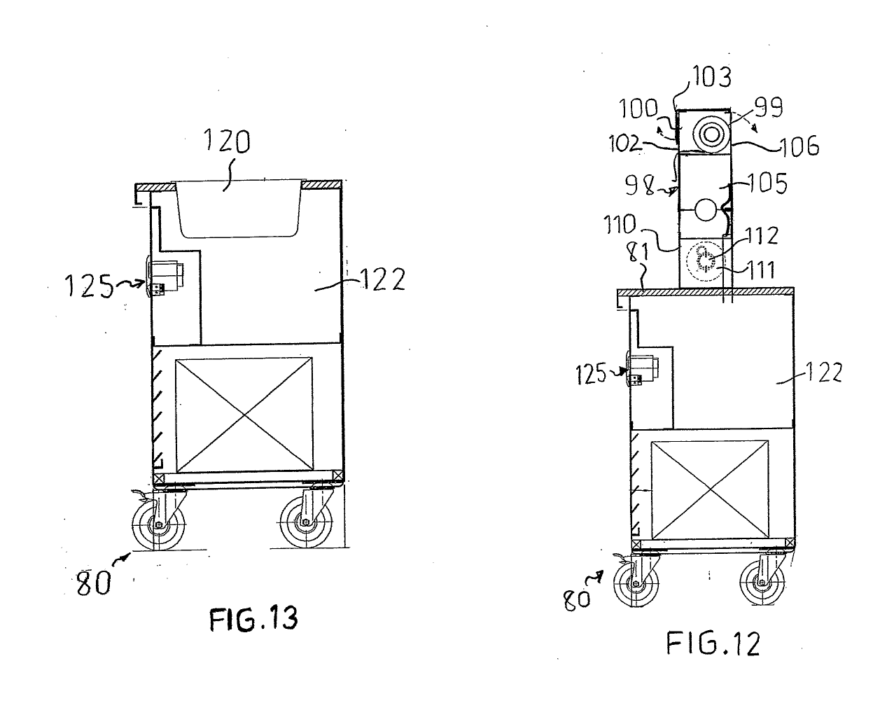

Referring now to FIGS. 8, 9, 10 and 12, a tower 98 extends upwardly from another part of the workbench 81. Three paper towel rolls 99 (shown in FIGS. 9 and 12) are housed within a top compartment 100 of the tower 98. Paper towel from the rolls 99 is dispensed through a slit 102 in the tower 98, as shown in FIG. 12. The compartment 100 is accessible by way of a hinged L-shaped door 103. An injector gun 101 containing a chocolate-filled cartridge 89 (shown in FIG. 8) extends through a middle compartment 105 of the tower 98. Opposed ends of the injector gun 101 extend through openings in the tower 98, as seen in FIG. 8. The middle compartment 105 is accessible by way of a sprung hinged door 106, as shown in FIG. 12. A lower compartment 110 of the tower 98 contains a paper towel dispenser 111, as shown in FIGS. 8 and 12. Paper towel is dispensed from a roll 112.

Referring now to FIG. 8, a heat lamp 107 extends from the tower 98 and heat from the lamp 107 keeps the chocolate within the injector gun 101 from solidifying. A shade 108 extends over the lamp.

A waste container 120 for paper towel and chocolate waste is located beneath a chocolate-filling end 121 of the injector gun 101 (shown in FIG. 8). The container 120 extends within a compartment 122, as shown in FIGS. 9, 12 and 13.

A control panel 125, for controlling and monitoring the refrigeration unit 86, the heating elements 87, the heating pad 94 and power outlets 95, is located beneath the tower 98. The control panel 125 is best seen in FIGS. 8, 12 and 13.

As shown in FIG. 8, castor wheels 127 enable the workstation 80 to be moved from one location to another.

Whilst the above has been given by way of illustrative example of the invention, many modifications and variations may be made thereto by persons skilled in the art without departing from the broad scope and ambit of the invention as herein set forth.

1. An apparatus for forming a cavity within a banana, said apparatus including at least one cutting tool having an arcuate tubular cutter extendible into a banana to form a longitudinally extending cavity within the banana.

2. The apparatus of claim 1, wherein the radius of the arc of the cutter is the same as or is similar to the radius of the banana, such that the cavity extends almost the entire length of the banana.

3. The apparatus of claim 1, wherein the cutter is of circular transverse cross-section.

4. The apparatus of claim 1, wherein the cutting tool further has a body and a handle extending from the body.

5. The apparatus of claim 4, wherein the body is arcuate when viewed in plan, the cutter extends longitudinally and completely through the body, and the handle extends upwardly from the body.

6. The apparatus of claim 5, wherein the cutter has a sharpened cutting end and an outlet end for pulp that has been cut from the banana.

7. The apparatus of claim 6 further having a positioning system for positioning the banana and the cutting tool relative to one another.

8. The apparatus of claim 7, wherein the positioning system includes a support surface having at least one arcuate track within which the banana and the cutting tool are located, and the track guides the movement of the cutting tool relative to the banana.

9. The apparatus of claim 8, wherein the track is a groove in the support surface.

10. The apparatus of claim 8, wherein the support surface includes at least one opening through which pulp may fall after having passed through the outlet end of the cutter.

11. The apparatus of claim 8, wherein the positioning system further includes a cutter guide extending transversely of and across the track adjacent an end of the banana, wherein the cutter guide has a body having an opening and the cutter extends through the opening.

12. The apparatus of claim 8 further including a container located below the support surface.

13. The apparatus of claim 8, wherein the support surface has an additional circular, semicircular or arcuate track and the apparatus includes an additional cutting tool located within the additional track.

14. The apparatus of claim 13, wherein the tracks extend concentrically to one another.

15. A method for forming a cavity within a banana, said method including the steps of:
moving a cutting tool having an arcuate tubular cutter into engagement with a banana such that the cutter extends into the banana to form a longitudinally extending cavity within the banana; and
removing the cutter from the banana.

16. The method of claim 15 further including the step of first removing a tip-end of the banana so that the cutter is extendible directly into the pulp of the banana.

17. A method of filling a banana with a product, such as a food product, said method including the steps of:
moving a cutting tool having an arcuate tubular cutter into engagement with a banana such that the cutter extends into the banana to form a longitudinally extending cavity within the banana;
removing the cutter from the banana; and
filling the cavity with a product.

18. The method of claim 17 further including the step of first removing a tip-end of the banana so that the cutter is extendible directly into the pulp of the banana.

19. The method of claim 17, wherein the food product is chocolate.

20. The method of claim 18 further including the step of sealing the cavity after the cavity has been filled with the product.

21. The method of claim 20, wherein the cavity is sealed by reattaching the tip-end of the banana to a remainder of the banana with beeswax.

22. A banana having an arcuate cavity extending longitudinally therewithin.

23. The banana of claim 22, wherein the cavity extends almost the entire length of the banana.

24. The banana of claim 22, wherein the cavity is filled with a product.

25. The banana of claim 24, wherein the product is chocolate.

26. The banana of claim 22, wherein a tip-end of the banana is attached to a remainder of the banana with beeswax.

27. The banana of claim 22, wherein a stem-end of the banana is cut and coated in beeswax.

28. A workstation having an apparatus for forming a cavity within a banana, said apparatus including at least one cutting tool having an arcuate tubular cutter extendible into a banana to form a longitudinally extending cavity within the banana.
